(19) United States
(12) Patent Application Publication
(10) Pub. No.: US 2024/0349316 A1
(43) Pub. Date: Oct. 17, 2024

(54) INFORMATION TRANSMISSION METHOD, COMMUNICATION DEVICE, AND READABLE STORAGE MEDIUM

(71) Applicant: GUANGDONG OPPO MOBILE TELECOMMUNICATIONS CORP., LTD., Dongguan (CN)

(72) Inventors: Qianxi LU, Dongguan (CN); Bingxue LENG, Dongguan (CN)

(21) Appl. No.: 18/754,940

(22) Filed: Jun. 26, 2024

Related U.S. Application Data
(63) Continuation of application No. PCT/CN2022/070782, filed on Jan. 7, 2022.

(51) Int. Cl. H04W 72/40; H04W 24/08; H04W 72/02; H04W 80/02

(52) U.S. Cl. CPC H04W 72/40; H04W 24/08; H04W 72/02; H04W 80/02

(57) ABSTRACT

An information transmission method is provided in the present application. In the information transmission method, in response that a target condition is met, a first UE sends resource selection auxiliary information to a second UE via a sidelink; where the target condition comprises at least one of: the first UE detecting, in the sidelink, an event that triggers the resource selection auxiliary information to be sent; or the first UE receiving request information sent by the second UE for requesting the resource selection auxiliary information.

### CROSS-REFERENCE TO RELATED APPLICATION

This application is a Bypass Continuation Application of PCT/CN2022/070782 filed Jan. 7, 2022, which is incorporated herein by reference in its entirety.

### TECHNICAL FIELD

The present disclosure relates to the field of the wireless communication technology, and in particular, to an information transmission method, a communication device, and a readable storage medium.

### BACKGROUND

With the development of Internet of Things technology, the D2D (device-to-device) communication has become a relatively common communication mode. The sidelink (Sidelink) is a new communication link introduced for supporting the D2D communication.

In a typical D2D transmission mode, a transmitting end UE (User Equipment) can select a resource from a sidelink resource pool, so as to send data to a receiving end UE through the selected resource. In order to enable the transmitting end UE to select an appropriate resource in the sidelink resource pool for sending data, resource selection auxiliary information (inter-UE coordination information) is introduced in the latest D2D research. The resource selection auxiliary information is sent by the receiving end UE to the transmitting end UE and is mainly used to assist the transmitting end UE for selecting a resource from the sidelink resource pool.

Currently, how to design D2D communication transmission for the resource selection auxiliary information has become an urgent problem to be solved.

### SUMMARY

In a first aspect, an information transmission method is provided in embodiments of the present disclosure, the method includes:
sending, by a first user equipment (UE), resource selection auxiliary information to a second UE via a sidelink in response that a target condition is met;
where the target condition includes at least one of the following:
the first UE detecting, in the sidelink, an event that triggers the resource selection auxiliary information to be sent; or the first UE receiving request information sent by the second UE for requesting the resource selection auxiliary information.

In a second aspect, an information transmission method is provided in the embodiments of the present disclosure, the method includes:
sending, by a second UE, request information to a first UE;
where the request information is used to request the first UE to feed back resource selection auxiliary information.

In a third aspect, a communication device is provided in the embodiments of the present disclosure, the communication device includes:
a first sending module, configured to send resource selection auxiliary information to a second UE via a sidelink in response that a target condition is met;
where the target condition includes at least one of the following:
detecting, in the sidelink, an event that triggers the resource selection auxiliary information to be sent; or
receiving request information sent by the second UE for requesting the resource selection auxiliary information.

In a fourth aspect, a communication device is provided in the embodiments of the present disclosure, the communication device includes:
a second sending module, configured to send request information to a first UE;
where the request information is used to request the first UE to feed back resource selection auxiliary information.

In a fifth aspect, a communication device is provided in the embodiments of the present disclosure, the communication device includes: a processor and a memory, where the memory is configured to store a computer program, the processor is configured to call and run the computer program stored in the memory to enable the communication device to perform the method according to the first aspect.

In a sixth aspect, a communication device is provided in the embodiments of the present disclosure, the communication device includes: a processor and a memory, where the memory is configured to store a computer program, the processor is configured to call and run the computer program stored in the memory to enable the communication device to perform the method according to the second aspect.

In a seventh aspect, a non-transitory computer readable storage medium is provided in the embodiments of the present disclosure, where the non-transitory computer readable storage medium is configured to store a computer program, and the computer program causes a communication device to perform the method according to the first aspect.

In an eighth aspect, a non-transitory computer readable storage medium is provided in the embodiments of the present disclosure, where the non-transitory computer readable storage medium is configured to store a computer program, and the computer program causes a communication device to perform the method according to the second aspect.

In a ninth aspect, a chip is provided in the embodiments of the present disclosure, where the chip includes a processing circuit for calling and running a computer program from a memory, so as to enable a communication device installed with the chip perform the method according to the first aspect.

In a tenth aspect, a chip is provided in the embodiments of the present disclosure, where the chip includes a processing circuit for calling and running a computer program from a memory, so as to enable a communication device installed with the chip perform the method according to the second aspect.

In an eleventh aspect, a computer program product is provided in the embodiments of the present disclosure, where the computer program product includes computer program instructions, and the computer program instructions cause a communication device to perform the method according to the first aspect.

In a twelfth aspect, a computer program product is provided in the embodiments of the present disclosure, where the computer program product includes computer program instructions, and the computer program instructions cause a communication device to perform the method according to the second aspect.

In a thirteenth aspect, a computer program is provided in the embodiments of the present disclosure, where the computer program causes a communication device to perform the method according to the first aspect.

In a fourteenth aspect, a computer program is provided in the embodiments of the present disclosure, where the computer program causes a communication device to perform the method according to the second aspect.

### BRIEF DESCRIPTION OF THE DRAWINGS

FIG. 1 is a schematic diagram of an implementing environment of an information transmission method provided in an embodiment.

FIG. 2 is a schematic diagram of an information transmission method provided in an embodiment.

FIG. 3 is a schematic diagram of an information transmission method provided in an embodiment.

FIG. 4 is a block diagram of a communication device provided in an embodiment.

FIG. 5 is a block diagram of a communication device provided in an embodiment.

FIG. 6 is a block diagram of a communication device provided in an embodiment.

FIG. 7 is a block diagram of a communication device provided in an embodiment.

FIG. 8 is a block diagram of a communication device provided in an embodiment.

FIG. 9 is a block diagram of a chip provided in an embodiment.

### DETAILED DESCRIPTION

In order to make the purpose, technical solutions, and advantages of the present disclosure clearer, the embodiments of the present disclosure may be described in detail below in conjunction with the drawings. It should be understood that the specific embodiments described herein are only used to explain the present disclosure, and not to limit the present disclosure.

With the development of Internet of Things technology, D2D communication (device-to-device communication) has become a relatively common communication mode.

In the 3GPP organization, D2D communication has gone through several different research phases, which mainly include the proximity based service (ProSe) research phase, the vehicle to everything (V2X) research phase and the further enhancements device to device (FeD2D, which means communication between wearable devices) research phase.

The ProSe is mainly aimed at a service of public safety; the V2X is mainly aimed at a service of vehicle-to-vehicle communication and vehicle-to-person communication; and the FeD2D is mainly aimed at a scenario where a wearable device accesses the network through a mobile phone, mainly targeting communications between devices with low-mobility rates and low-power.

In order to support D2D communication, a communication system introduces a sidelink in addition to the traditional uplink (UPlink) and downlink (Downlink), where the sidelink is a communication link used for D2D communication between devices.

At present, there are two mainstream D2D communication modes.

Mode A: a base station allocates a resource for a user equipment (UE) in the sidelink, and the UE sends data using the resource allocated by the base station. The base station can dynamically allocate a resource for the UE or semi-statically allocate a resource for the UE.

Mode B: the UE selects a resource from a sidelink resource pool to send data.

It should be noted that in a new radio (NR) communication system, in addition to using a mode provided in mode A or mode B alone to acquire a resource in the sidelink, the UE can also use a mixture of mode A and mode B to acquire a resource in the sidelink.

In mode B, the UE needs to monitor the sidelink to determine an occupancy situation of the resources in the sidelink resource pool by monitoring. When there are requirements for the UE to send data, the UE can select a resource from the sidelink resource pool based on a monitoring result of the sidelink.

However, the D2D communication system often includes multiple UEs, and a certain UE in the multiple UEs can only determine its own behaviors, but cannot know the behaviors of other UEs. Therefore, the following exemplary phenomena are likely to occur.
1. A UE selects a resource A from the sidelink resource pool to send data based on the monitoring result of the sidelink, and another UE also selects the resource A from the sidelink resource pool to send data based on the monitoring result of the sidelink, which may cause a high interference level of the resource A, thereby affecting the reception for the data.
2. A UE selects a resource A from the sidelink resource pool to send data based on the monitoring result of the sidelink. However, a receiving end UE needs to send data when the resource A arrives. Due to the limitation of the half duplex, the receiving end UE cannot receive the data on the resource A.

Due to the existence of the above phenomena, the resource selected by the UE from the sidelink resource pool may not be a suitable resource. For this reason, Rel-17 introduces resource selection auxiliary information (inter-UE coordination information) in the D2D communication, that is, the receiving end UE can send the resource selection auxiliary information to the transmitting end UE, thereby helping the transmitting end UE to make a more optimal resource selection. Furthermore, a decision was reached in the RAN1 #107 meeting to use a MAC CE to transmit the resource selection auxiliary information.

The MAC CE is an abbreviation of MAC (media access control) control element. MAC CE is similar to radio resource control (Radio Resource Control, RRC) information and non-access stratum (Non-Access Stratum, NAS), and is a container (container) used to transmit control information. As the name suggests, the MAC CE is generally used to transmit control information about a MAC layer.

Although the RAN1 #107 meeting reached a decision to use the MAC CE to transmit resource selection auxiliary information, a consensus on how to transmit MAC CE has not been reached in the art, which is an urgent problem to be solved in the design for the D2D communication transmission regarding the resource selection auxiliary information.

In view of this, an information transmission method is provided in the embodiments of the present disclosure, and the information transmission method mainly focuses on a triggering condition of MAC CE transmission. Designing the triggering condition of the MAC CE transmission is helpful for solving the problem that needs to be solved urgently in the current D2D communication research.

The implementation environment involved in the information transmission method provided in the embodiments of the present disclosure may be briefly described below.

The embodiments of the present disclosure provide an information transmission method applied to a first UE. The method includes:
sending, by a first UE, resource selection auxiliary information to a second UE via a sidelink in response that a target condition is met;
where the target condition comprises at least one of:
the first UE detecting, in the sidelink, an event that triggers the resource selection auxiliary information to be sent; or
the first UE receiving request information sent by the second UE for requesting the resource selection auxiliary information.

In some embodiments, the sending, by the first UE, the resource selection auxiliary information to the second UE via the sidelink includes:
sending, by the first UE, a MAC CE including the resource selection auxiliary information to the second UE via the sidelink.

In some embodiments, the first UE detecting, in the sidelink, the event that the resource selection auxiliary information is triggered to be sent includes:
the first UE detecting, in the sidelink, a resource conflict event.

In some embodiments, the first UE detecting, in the sidelink, the resource conflict event includes:
the first UE detecting that an interference level of a first resource in the sidelink is greater than an interference threshold; or,
the first UE being unable to perform a reception on the first resource; where the first resource is used to carry data sent by the second UE to the first UE.

In some embodiments, the target condition further includes:
a current time being a time for sending the resource selection auxiliary information.

In some embodiments, the current time being the time for sending the resource selection auxiliary information includes:
the current time being a time that the first UE periodically sends the resource selection auxiliary information to the second UE.

In some embodiments, the request information is information carried in a physical sidelink control channel (PSCCH); or, the request information is included in a MAC CE; or, the request information is included in radio resource control (RRC) information.

In some embodiments, in response that the target condition is the first UE receiving the request information sent by the second UE, the method further includes:
discarding, by the first UE, the MAC CE or canceling, by the first UE, the MAC CE in response that the first UE fails to send the MAC CE within a first duration.

In some embodiments, the method further includes:
stopping, by the first UE, transmitting the MAC CE until the target condition is met again in response that the first UE fails to send the MAC CE within the first duration.

In some embodiments, a starting time of the first duration is determined according to the request information.

In some embodiments, a starting time of the first duration is determined according to a time that the first UE receives a transmission of the request information for a last time; or, the starting time of the first duration is determined according to a time that the first UE feeds back an ACK to the second UE for the request information.

In some embodiments, in response that the target condition is the first UE receiving the request information sent by the second UE, the method further includes:
starting, by the first UE, a first timer, where a timer duration of the first timer is a first duration.

In some embodiments, the method further includes:
discarding, by the first UE, or canceling, by the first UE, the MAC CE in response that the first timer expires.

In some embodiments, the method further includes:
stopping, by the first UE, the first timer in response that the first UE sends or generates the MAC CE before the first timer expires.

In some embodiments, a starting time of the first timer is determined according to the request information.

In some embodiments, a starting time of the first timer is determined according to a time that the first UE receives a transmission of the request information for the last time; or, the starting time of the first timer is determined according to a time that the first UE feeds back an ACK to the second UE for the request information.

In some embodiments, after the discarding, by the first UE, the MAC CE or canceling, by the first UE, the MAC CE, the method further includes:
sending, by the first UE, a new MAC CE including new resource selection auxiliary information to the second UE via the sidelink.

In some embodiments, the sending, by the first UE, the new MAC CE including the new resource selection auxiliary information to the second UE via the sidelink includes:
sending, by the first UE, the new MAC CE including the new resource selection auxiliary information to the second UE via the sidelink in response that a count the first UE sends the MAC CE to the second UE after the target condition is met is less than a count threshold.

In some embodiments, the method further includes:
stopping, by the first UE, transmitting the MAC CE before the target condition is met again in response that the count the first UE sends the MAC CE to the second UE after the target condition is met is greater than or equal to a count threshold.

In addition, the embodiments of the present disclosure further provide an information transmission method applied to a second UE. The method includes:
sending, by a second UE, request information to a first UE, where the request information is used to request the first UE to feed back resource selection auxiliary information.

In some embodiments, the request information is information carried in a PSCCH; or, the request information is included in a MAC CE; or, the request information is included in RRC information.

In some embodiments, the method further includes:
selecting, by the second UE, a second resource from a sidelink resource pool based on the resource selection auxiliary information included in a received MAC CE and a monitoring result of the sidelink if the second UE receives the MAC CE sent by the first UE in response to the request information within a second duration;
where the second resource is used to carry data sent by the second UE to the first UE.

In some embodiments, the method further includes:
selecting, by the second UE, the second resource from the sidelink resource pool based on a monitoring result of the sidelink if the second UE fails to receive a MAC CE sent by the first UE in response to the request information within a second duration.

In some embodiments, a starting time of the second duration is determined according to the request information.

In some embodiments, a starting time of the second duration is determined according to a time that the second UE sends a transmission of the request information to the first UE for the last time; or, the starting time of the second duration is determined according to a time that the second UE receives an ACK from the first UE for the request information.

In some embodiments, the method further includes:
starting, by the second UE, a second timer, where a timer duration of the second timer is a second duration.

In some embodiments, the method further includes:
selecting, by the second UE, a second resource from a sidelink resource pool based on the resource selection auxiliary information included in a received MAC CE and a monitoring result of the sidelink if the second UE receives the MAC CE sent by the first UE in response to the request information before the second timer expires;
where the second resource is used to carry data sent by the second UE to the first UE.

In some embodiments, the method further includes:
selecting, by the second UE, the second resource from the sidelink resource pool based on a monitoring result of the sidelink in response that the second timer expires.

In some embodiments, the method further includes:
stopping, by the second UE, the second timer if the second UE receives a MAC CE sent by the first UE in response to the request information before the second timer expires.

In some embodiments, a starting time of the second timer is determined according to the request information.

In some embodiments, a starting time of the second timer is determined according to a time that the second UE sends a transmission of the request information to the first UE for the first time; or, the starting time of the second timer is determined according to a time that the second UE receives an ACK from the first UE for the request information.

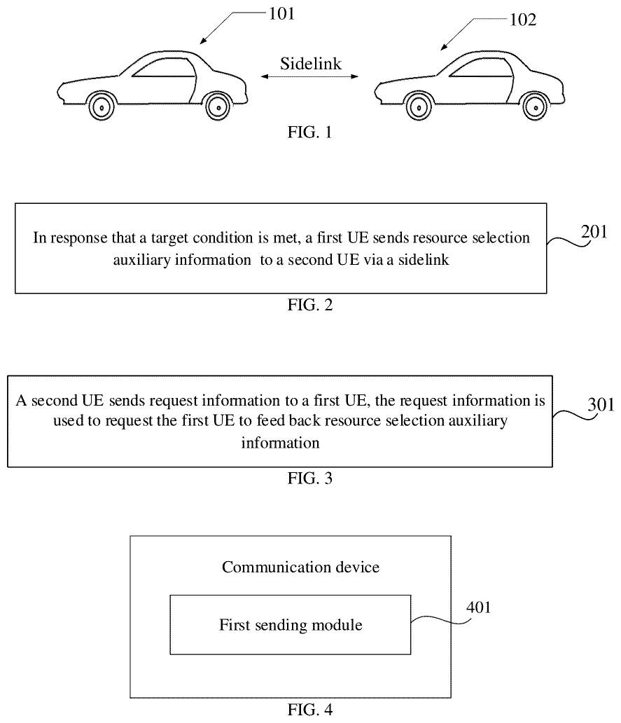

Referring to FIG. 1, FIG. 1 shows a possible implementation environment involved in the embodiments of the present disclosure. As shown in FIG. 1, the implementation environment may include a first UE 101 and a second UE 102, where the first UE 101 and the second UE 102 can perform D2D communication via a sidelink.

It should be noted that, although not shown in FIG. 1, the first UE 101 and the second UE 102 can also communicate with a base station, where the base station herein can be: a base transceiver station (base transceiver station, BTS) in a global system for mobile communication (global system for mobile communication, GSM) or a code division multiple access (code division multiple access, CDMA) network, or a NodeB (NB) in a wideband code division multiple access (wideband code division multiple access, WCDMA) network, or an evolutional NB (eNB) or evolutional NodeB (eNodeB) in a long term evolution (long term evolution, LTE) network, or a gNB in an NR system.

The first UE 101 and the second UE 102 may be smart phones, computers, multimedia players, e-readers, wearable devices, sensor devices, vehicles or vehicle-mounted terminals, etc.

It should be noted that, for the sake of convenience of explanation, in the embodiments of the present disclosure, the first UE 101 is used as the receiving end UE and the second UE 102 is used as the transmitting end UE. The reader should understand that in addition to receiving data, the first UE 101 can also send data in some other scenarios, and the second UE 102 can also receive data in addition to sending data in some other scenarios.

Referring to FIG. 2, FIG. 2 shows a flowchart of an information transmission method provided in the embodiments of the present disclosure. The information transmission method can be applied to the first UE 101 in the implementation environment shown in FIG. 1. As shown in FIG. 2, the method may include the following steps.

Step 201: in response that a target condition is met, a first UE sends resource selection auxiliary information to a second UE via a sidelink.

Optionally, the first UE can use a MAC CE as a container to transmit the resource selection auxiliary information. Of course, in possible future communication standards and application scenarios, other signalings may be used as containers to transmit the resource selection auxiliary information, such as an RRC signaling, etc., which is not specifically limited in the embodiments of the present disclosure.

The target condition includes at least one of the following: the first UE detecting, in the sidelink, an event that triggers the resource selection auxiliary information to be sent; or the first UE receiving request information sent by the second UE for requesting the resource selection auxiliary information. In addition, the target condition may further include: a current time being a time for sending the resource selection auxiliary information.

The above three target conditions would be explained in the embodiments of the present disclosure respectively below.

The first target condition: the first UE detecting, in the sidelink, an event that triggers the resource selection auxiliary information to be sent.

In an optional embodiment of the present disclosure, if the first UE detects a specific event in the sidelink, the first UE may determine that resource currently selected by the second UE from the sidelink resource pool for carrying data sent by the second UE to the first UE are not a preferred resource. In this situation, the first UE can send resource selection auxiliary information to the second UE to help the second UE make an optimized selection for resources in subsequent data transmission processes.

The specific event mentioned above may be a resource conflict event. Optionally, the resource conflict event may include the following events.

A. the first UE detecting that an interference level of a first resource in the sidelink is greater than an interference threshold, where the first resource is used to carry data sent by the second UE to the first UE.

If the first UE detects that the interference level of the first resource is greater than the interference threshold, it means that in addition to the second UE, there are other UEs that select the first resource to send data, which is a resource conflict event.

B. the first UE being unable to perform a reception on the first resource.

In actual applications, when the first resource arrives, the first UE may have data of a service with a higher priority needed to be sent. Due to the limitation of the half duplex, the first UE cannot perform a reception operation on the first resource, which is also a resource conflict event.

The second target condition: a current time being a time for sending the resource selection auxiliary information.

In an optional embodiment of the present disclosure, the first UE may send resource selection auxiliary information to the second UE at certain specific times, where the specific times mentioned above may be agreed between the first UE and the second UE, or may be configured by a base station, or may be determined according to a communication protocol, which may not be limited in the embodiments of the present disclosure. If the current time happens to be the time for the first UE sending the resource selection auxiliary information to the second UE, the first UE can send the resource selection auxiliary information to the second UE to help the second UE perform a more optimized selection for resources in the processes of sending data to the first UE.

Optionally, in a situation that a unicast link is established between the first UE and the second UE, the first UE may periodically send the resource selection auxiliary information to the second UE, so that when the second UE needs to send data to the first UE, the second UE can select an more optimal resource from the sidelink resource pool according to the resource selection auxiliary information most recently sent by the first UE, or according to the resource selection auxiliary information sent by the first UE within a target time length before the current time. In this situation, the current time being the time for sending the resource selection auxiliary information may be: the current time being a time that the first UE periodically sends the resource selection auxiliary information to the second UE.

The third target condition: the first UE receiving request information sent by the second UE for requesting the resource selection auxiliary information.

In an optional embodiment of the present disclosure, the second UE may send the request information to the first UE when data transmission to the first UE is triggered. The second UE may also send the request information to the first UE when receiving a NACK (negative acknowledgment) from the first UE for the sent data. The second UE may also send the request information to the first UE when receiving a count of n (>1) NACKs from the first UE for the sent data. The second UE may also periodically send the request information to the first UE, and an occasion for the second UE to send the request information to the first UE is not limited in the embodiments of the present disclosure. After receiving the request information sent by the second UE, the first UE may send the resource selection auxiliary information to the second UE.

The request information may be information carried in PSCCH (Physical Uplink Control Channel), or the request information may be included in the MAC CE, or the request information may be included in RRC information, where when the request information is included in the MAC CE or in the RRC information, the request information is carried in PSSCH (Physical Sidelink Share Channel).

In the third target condition, optionally, if the first UE fails to send the MAC CE within a first duration, the first UE discards (discard) the MAC CE, or cancels (cancel) the MAC CE.

In actual applications, the first UE needs to wait for an appropriate sidelink resource to send the MAC CE. Therefore, if the first UE fails to wait for the appropriate sidelink resource within the first duration, there may be a situation where the first UE fails to send the MAC CE within the first duration. In addition, in the actual applications, it often takes a certain amount of time for the first UE to generate the MAC CE. If the first UE fails to successfully generate the MAC CE within the first duration, there may be a situation where the first UE fails to send the MAC CE within the first duration. Of course, in the actual applications, there are other reasons why the first UE fails to send the MAC CE within the first duration, which is not repeated herein in the embodiments of the present disclosure.

The timeliness of the resource selection auxiliary information is generally strong. Therefore, if the first UE fails to send the MAC CE within the first duration, the effectiveness of the resource selection auxiliary information included in the MAC CE may be reduced or even lost, and the assistance of the resource selection auxiliary information for the second UE in selecting a resource may also be reduced or even lost. Considering this situation, if the first UE fails to send the MAC CE within the first duration, the first UE can discard the MAC CE, or cancel the MAC CE.

Further, in a possible implementation, if the first UE fails to send the MAC CE within the first duration, the first UE stops transmitting the MAC CE before the target condition is met again. In other words, if the first UE fails to send the MAC CE within the first duration, the first UE may discard the MAC CE, or cancel the MAC CE. After that, the first UE may no longer attempt to send a MAC CE to the second UE until the target condition is met again.

In the actual applications, considering the problem of latency in data transmission, the second UE cannot wait indefinitely for the first UE to feed back the resource selection auxiliary information after sending the request information to the first UE. Otherwise, an increase in the latency of the second UE selecting a resource may lead to be increased, thereby causing an increase in the latency of the second UE sending data to the first UE. Considering this, if the first UE fails to send the MAC CE within the first duration, the first UE can no longer attempt to send the MAC CE to the second UE until the target condition is met again.

In another possible implementation, after the first UE discards the MAC CE or cancels the MAC CE, the first UE may attempt to send a MAC CE to the second UE again, that is, the first UE may send a new MAC CE including new resource selection auxiliary information to the second UE via the sidelink.

In the actual applications, if the second UE sends a request message to the first UE, it means that the second UE needs to select a resource based on the resource selection auxiliary information sent by the first UE. In order to ensure that the second UE can make a more optimized resource selection, the first UE can attempt to send a MAC CE to the second UE again after discarding the MAC CE or canceling the MAC CE.

It should be noted that in this implementation, the first UE cannot attempt to send the MAC CE to the second UE without limitation. Before attempting to send a MAC CE again, the first UE can determine whether a count of times of the first UE sending the MAC CE to the second UE after meeting the target condition is less than a count threshold. If so, the first UE can attempt to send a MAC CE again, that is, the first UE sends a new MAC CE including new resource selection auxiliary information to the second UE through the sidelink. If not, the first UE stops transmitting the MAC CE before meeting the target condition again.

A starting time of the first duration would be explained in the embodiments of the present disclosure below.

In a possible implementation, the starting time of the first duration may be determined according to the request information.

Further, as described above, the request information may be information carried in the PSCCH. In this situation, the starting time of the first duration may be determined according to a time domain position of the request information in the PSCCH.

In another possible implementation, the starting time of the first duration can be determined according to a time that the first UE receives a transmission of the request information for the last time, or the starting time of the first duration can be determined according to a time that the first UE feeds back an ACK (acknowledgement) to the second UE for the request information.

As mentioned above, the request information may be included in the MAC CE or the RRC information. In this situation, a MAC layer or a RRC layer may involve a retransmission of the request information. For example, in the HARQ (hybrid automatic repeat request) mechanism, the first UE may feed a NACK back to the second UE without correctly receiving the request information, and the second UE may retransmit the request information after receiving the NACK.

Taking into account that the MAC layer or RRC layer may involve the retransmission of request information. Therefore, in this situation, the starting time of the first duration may be determined according to the time that the first UE receives the transmission of the request information for the last time, or the starting time of the first duration may be determined according to the time that the first UE feeds back an ACK to the second UE for the request information. In other words, the starting time of the first duration may be determined according to a time that the request information is correctly received.

In the third target condition, optionally, the first UE may start a first timer, where a timer duration of the first timer may be the first duration. If the first UE sends a MAC CE or generates a MAC CE before the first timer expires, the first UE stops the first timer. If the first timer expires, the first UE discards the MAC CE or cancels the MAC CE.

As mentioned above, in actual applications, the first UE needs to wait for an suitable sidelink resource to send the MAC CE. Therefore, if the first UE fails to wait for an suitable sidelink resource before the first timer expires, a situation that the first UE fails to send the MAC CE before the first timer expires may occur. In addition, in the actual applications, it often takes a certain amount of time for the first UE to generate a MAC CE. If the first UE fails to successfully generate a MAC CE before the first timer expires, a situation that the first UE fails to send the MAC CE before the first timer expires may occur. Of course, in the actual applications, there are other reasons why the first UE fails to send the MAC CE before the first timer expires, which is not repeated herein in the embodiments of the present disclosure.

Based on the consideration of the timeliness of the resource selection auxiliary information mentioned above, if the first timer expires, the first UE may discard the MAC CE, or cancel the MAC CE.

Further, in a possible implementation, if the first timer expires, the first UE stops transmitting the MAC CE before the target condition is met again. In other words, if the first timer expires, the first UE may discard the MAC CE, or cancel the MAC CE, after which the first UE may no longer attempt to send a MAC CE to the second UE until the target condition is met again.

In another possible implementation, after the first UE discards the MAC CE or cancels the MAC CE, the first UE may attempt to send a MAC CE to the second UE again, that is, the first UE may send a new MAC CE including new resource selection auxiliary information to the second UE via the sidelink.

As described above, in this implementation, the first UE cannot attempt to send the MAC CE to the second UE without limitation. Before attempting to send a MAC CE again, the first UE can determine whether a count of times of the first UE sending the MAC CE to the second UE after meeting the target condition is less than a count threshold. If so, the first UE may attempt to send a MAC CE again, that is, the first UE sends a new MAC CE including new resource selection auxiliary information to the second UE through the sidelink. If not, the first UE stops transmitting the MAC CE before meeting the target condition again.

A starting time of the first timer would be explained in the embodiments of the present disclosure below.

In a possible implementation manner, the starting time of the first timer may be determined according to the request information.

Further, as described above, the request information may be information carried in the PSCCH. In this situation, the starting time of the first timer may be determined according to a time domain position of the request information in the PSCCH.

In another possible implementation, the starting time of the first timer can be determined according to a time that the first UE receives a transmission of the request information for the last time, or the starting time of the first timer can be determined according to a time that the first UE feeds back an ACK to the second UE for the request information.

As described above, the request information may be included in the MAC CE, or in the RRC information. In this situation, taking into account a retransmission of the request information, the starting time of the first timer may be determined according to the time that the first UE receives the transmission of the request information for the last time, or the starting time of the first timer may be determined according to the time that the first UE feeds back the ACK to the second UE for the request information. In other words, the starting time of the first timer can be determined according to the time that the request information is correctly received.

Referring to FIG. 3, FIG. 3 shows a flowchart of an information transmission method provided in the embodiments of the present disclosure. The information transmission method can be applied to the second UE 102 in the implementing environment shown in FIG. 1. As shown in FIG. 3, the method may include the following steps.

Step 301: sending, by a second UE, request information to a first UE. The request information is used to request the first UE to feed back resource selection auxiliary information.

In an optional embodiment of the present disclosure, the second UE may send request information to the first UE when data transmission to the first UE is triggered. The second UE may also send request information to the first UE when receiving NACK from the first UE for the sent data. The second UE may also send request information to the first UE when receiving n (>1) NACKs from the first UE for the sent data. The second UE may also periodically send request information to the first UE. The embodiment of the present disclosure does not limit the timing when the second UE sends request information to the first UE.

As described above, the request information may be information carried in the PSCCH, or the request information may be included in a MAC CE, or the request information may be included in RRC information.

As described above, considering the problem of latency in data transmission, after sending the request information to the first UE, the second UE cannot wait indefinitely for the first UE to feed back resource selection auxiliary information. Otherwise, an increase in the latency of the second UE selecting a resource may lead to be increased, thereby causing an increase in the latency of the second UE sending data to the first UE, and considering this:
optionally, if within a second duration, the second UE receives a MAC CE sent by the first UE in response to the request information, the second UE selects a second resource from a sidelink resource pool based on the resource selection auxiliary information included in the received MAC CE and a monitoring result of the sidelink, where the second resource is used to carry data sent by the second UE to the first UE. However, if the second UE fails to receive a MAC CE sent by the first UE in response to the request information within the second duration, the second UE selects the second resource from the sidelink resource pool based on the monitoring result of the sidelink.

It should be noted that, in order to ensure the consistency of actions of the first UE and the second UE, the first duration and the second duration need to be aligned. In other words, lengths of the first duration and the second duration need to be consistent, and starting times of the first duration and the second duration are consistent.

Similar to the starting time of the first duration described above, in a possible implementation, a starting time of the second duration may be determined according to the request information.

Further, as described above, the request information may be information carried in the PSCCH. In this situation, the starting time of the second duration may be determined according to a time domain position of the request information in the PSCCH.

In another possible implementation, considering the retransmission of the request information, the starting time of the second duration can be determined according to a time that the second UE sends a transmission of the request information to the first UE for the last time, or the starting time of the second duration can be determined according to a time that the second UE receives an ACK from the first UE for the request information. In other words, the starting time of the second duration may be determined according to a time that the request information is correctly received.

Optionally, the second UE may start a second timer, where the timer duration of the second timer is the second duration. If the second UE receives a MAC CE sent by the first UE in response to the request information before the second timer expires, the second UE stops the second timer, and in addition, the second UE selects the second resource from the sidelink resource pool based on the resource selection auxiliary information included in the received MAC CE and a monitoring result of the sidelink. If the second timer expires, the second UE selects the second resource from the sidelink resource pool based on the monitoring result of the sidelink.

In order to ensure the consistency of actions of the first UE and the second UE, the first timer and the second timer need to be aligned. In other words, lengths of the timer duration of the first timer (i.e., the first duration) and the timer duration of the second timer (i.e., the second duration) need to be consistent, and the starting time of the first timer is consistent with the starting time of the second timer.

Similar to the starting time of the first timer mentioned above, in a possible implementation manner, the starting time of the second timer can be determined according to the request information.

Further, as described above, the request information may be information carried in the PSCCH. In this situation, the starting time of the second timer may be determined according to a time domain position of the request information in the PSCCH.

In another possible implementation, considering the retransmission of the request information, the starting time of the second timer can be determined according to the time that the second UE sends a transmission of the request information to the first UE for the last time, or the starting time of the second timer can be determined according to the time that the second UE receives an ACK from the first UE for the request information. In other words, the starting time of the second timer can be determined according to the time that the request information is correctly received.

In an embodiment, as shown in FIG. 4, a communication device 400 is provided. The communication may be, for example, a first UE. The communication device 400 includes: a first sending module 401.

The first sending module 401 is configured to send resource selection auxiliary information to a second UE via a sidelink in response that a target condition is met.

The target condition includes at least one of the following:
detecting, in the sidelink, an event that triggers the resource selection auxiliary information to be sent; or
receiving request information sent by the second UE for requesting the resource selection auxiliary information.

In an optional embodiment of the present disclosure, the first sending module 401 is specifically configured to: send a MAC CE including the resource selection auxiliary information to the second UE via the sidelink.

In an optional embodiment of the present disclosure, detecting, in the sidelink, an event that triggers the resource selection auxiliary information to be sent includes: detecting a resource conflict event in the sidelink.

In an optional embodiment of the present disclosure, detecting a resource conflict event in the sidelink includes:
detecting that an interference level of a first resource in the sidelink is greater than an interference threshold; or,
being unable to perform a reception on the first resource;
where the first resource is used to carry data sent by the second UE to the first UE.

In an optional embodiment of the present disclosure, the target condition further includes: a current time being a time for sending the resource selection auxiliary information.

In an optional embodiment of the present disclosure, the current time being the time for sending the resource selection auxiliary information includes: the current time being a time that the resource selection auxiliary information is sent to the second UE periodically.

In an optional embodiment of the present disclosure, the request information is information carried in a physical sidelink control channel (PSCCH); or,
the request information is included in a MAC CE; or,
the request information is included in radio resource control (RRC) information.

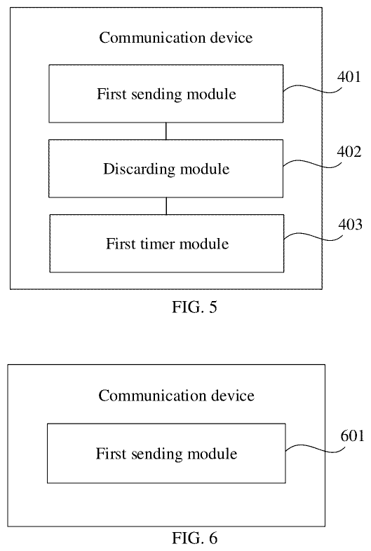

Referring to FIG. 5, FIG. 5 shows another communication device 500 provided in the embodiments of the present disclosure. The communication device 500 may be, for example, a first UE. In addition to the modules in the communication device 400, the communication device 500 also includes a discarding module 402 and a first timer module 403.

In an optional embodiment of the present disclosure, in response that the target condition is receiving the request information sent by the second UE, the discarding module 402 is configured to: discard the MAC CE or cancel the MAC CE in response that the MAC CE is failed to be sent within a first duration.

In an optional embodiment of the present disclosure, a sending module 501 is further configured to: stop transmitting the MAC CE until the target condition is met again in response that the MAC CE is failed to be sent within a first duration.

In an optional embodiment of the present disclosure, a starting time of the first duration is determined according to the request information.

In an optional embodiment of the present disclosure, a starting time of the first duration is determined according to a time that the first UE receives a transmission of the request information for a last time; or, the starting time of the first duration is determined according to a time that the first UE feeds back an ACK to the second UE for the request information.

In an optional embodiment of the present disclosure, in response that the target condition is receiving the request information sent by the second UE, the first timer module 403 is configured to: start a first timer, where a timer duration of the first timer is a first duration.

In an optional embodiment of the present disclosure, the discarding module 402 is configured to: discard the MAC CE or cancel the MAC CE if the first timer expires.

In an optional embodiment of the present disclosure, the first timer module 403 is further configured to: stop the first timer in response that the first UE sends or generates the MAC CE before the first timer expires.

In an optional embodiment of the present disclosure, a starting time of the first timer is determined according to the request information.

In an optional embodiment of the present disclosure, the starting time of the first timer is determined according to a time that the first UE receives a transmission of the request information for the last time; or, the starting time of the first timer is determined according to a time that the first UE feeds back an ACK to the second UE for the request information.

In an optional embodiment of the present disclosure, the first sending module 401 is further configured to send a new MAC CE including new resource selection auxiliary information to the second UE via the sidelink after discarding the MAC CE or canceling the MAC CE.

In an optional embodiment of the present disclosure, the first sending module 401 is specifically configured to: send the new MAC CE including the new resource selection auxiliary information to the second UE via the sidelink in response that a count the MAC CE is sent to the second UE after the target condition is met is less than a count threshold.

In an optional embodiment of the present disclosure, the first sending module 401 is further configured to: stop transmitting the MAC CE before the target condition is met again in response that the count the MAC CE is sent to the second UE after the target condition is met is greater than or equal to a count threshold.

For specific limitations on the communication device may refer to the limitations on the information transmission method described above, which is not repeated herein. Each module in the above communication devices may be implemented in whole or in part by software, hardware or a combination thereof. The above modules may be embedded in or independent from a processor in the communication device in the form of hardware, or may be stored in a memory in the communication device in the form of software, so that the processor can call and execute operations corresponding to the above modules.

In an embodiment, as shown in FIG. 6, a communication device 600 is provided. The communication may be, for example, a second UE. The communication device 600 includes: a second sending module 601.

The second sending module 601 is configured to send request information to a first UE; where the request information is used to request the first UE to feed back resource selection auxiliary information.

In an optional embodiment of the present disclosure, the request information is information carried in a PSCCH; or, the request information is included in a MAC CE; or, the request information is included in RRC information.

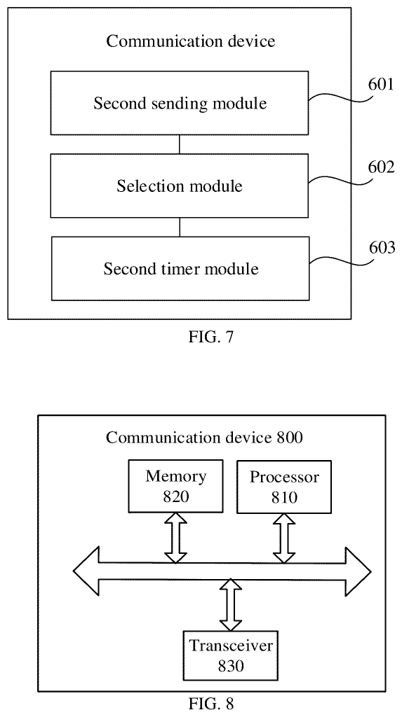

Referring to FIG. 7, another communication device 700 is provided in the embodiments of the present disclosure. The communication device 700 may be, for example, a second UE. In addition to the modules in the communication device 600, the communication device 700 also includes a selection module 602 and a second timer module 603.

In an optional embodiment of the present disclosure, the selection module 602 is configured to: select a second resource from a sidelink resource pool based on the resource selection auxiliary information included in a received MAC CE and a monitoring result of the sidelink if the MAC CE sent by the first UE in response to the request information is received within a second duration; where the second resource is used to carry data sent by the second UE to the first UE.

In an optional embodiment of the present disclosure, the selection module 602 is configured to: select the second resource from the sidelink resource pool based on a monitoring result of the sidelink if a MAC CE sent by the first UE in response to the request information is failed to be received within a second duration.

In an optional embodiment of the present disclosure, a starting time of the second duration is determined according to the request information.

In an optional embodiment of the present disclosure, a starting time of the second duration is determined according to a time that the second UE sends a transmission of the request information to the first UE for the last time; or, the starting time of the second duration is determined according to a time that the second UE receives an ACK from the first UE for the request information.

In an optional embodiment of the present disclosure, the second timer module 603 is configured to: start a second timer, where a timer duration of the second timer is a second duration.

In an optional embodiment of the present disclosure, the selection module 602 is further configured to: select a second resource from a sidelink resource pool based on the resource selection auxiliary information included in a received MAC CE and a monitoring result of the sidelink if the MAC CE sent by the first UE in response to the request information is received before the second timer expires; where the second resource is used to carry data sent by the second UE to the first UE.

In an optional embodiment of the present disclosure, the selection module 602 is further configured to: select the second resource from the sidelink resource pool based on a monitoring result of the sidelink in response that the second timer expires.

In an optional embodiment of the present disclosure, the second timer module 603 is further configured to: stop the second timer if a MAC CE sent by the first UE in response to the request information is received before the second timer expires.

In an optional embodiment of the present disclosure, a starting time of the second timer is determined according to the request information.

In an optional embodiment of the present disclosure, a starting time of the second timer is determined according to a time that the second UE sends a transmission of the request information to the first UE for the first time; or, the starting time of the second timer is determined according to a time that the second UE receives an ACK from the first UE for the request information.

For specific limitations on the communication device may refer to the limitations on the information transmission method described above, which is not repeated herein. Each module in the above communication devices may be implemented in whole or in part by software, hardware or a combination thereof. The above modules may be embedded in or independent from a processor in the communication device in the form of hardware, or may be stored in a memory in the communication device in the form of software, so that the processor can call and execute operations corresponding to the above modules.

FIG. 8 is a schematic structural diagram of a communication device provided in the embodiments of the present disclosure. The communication device may be a UE. The communication device 800 shown in FIG. 8 includes a processor 810. The processor 810 may call and run a computer program from a memory to implement the methods in the embodiments of the present disclosure.

In some embodiments, as shown in FIG. 8, the communication device 800 may further includes a memory 820. The processor 810 may call and run the computer programs from the memory 820 to implement the methods in the embodiments of the present disclosure.

The memory 820 may be a separate assembly independent from the processor 810, or may be integrated into the processor 810.

In some embodiments, as shown in FIG. 8, the communication device 800 may further include a transceiver 830, and the processor 810 may control the transceiver 830 to communicate with other devices, specifically, may send information or data to other devices, or receive information or data sent by other devices.

The transceiver 830 may include a transmitter and a receiver. The transceiver 830 may further include antennas, and a number of the antennas may be one or more.

In some embodiments, the communication device 800 may implement the corresponding procedure implemented by the UE in the various methods of the embodiments of the present disclosure, which will not be repeated herein for the sake of brevity.

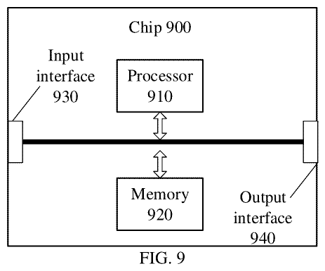

FIG. 9 a schematic structural diagram of a chip of the embodiments of the present disclosure. The chip 900 shown in FIG. 9 includes a processor 910, which may call and run computer programs from a memory to implement the methods in the embodiments of the present disclosure.

In some embodiments, as shown in FIG. 9, the chip 900 may further include a memory 920. The processor 910 may call and run the computer programs from the memory 920 to implement the methods in the embodiments of the present disclosure.

Herein, the memory 920 may be a separate device independent from the processor 910, or may also be integrated into the processor 910.

In some embodiments, the chip 900 may further include an input interface 930. The processor 910 may control the input interface 930 to communicate with other devices or chips. Specifically, the processor 910 may obtain information or data sent by the other devices or chips.

In some embodiments, the chip 900 may further include an output interface 940. The processor 910 may control the output interface 940 to communicate with the other devices or chips. Specifically, the processor 910 may output information or data to the other devices or chips.

In some embodiments, the chip 900 may be applied to the communication device in the embodiments of the present disclosure, and the chip 900 may implement the corresponding procedure implemented by the UE in the various methods of the embodiments of the present disclosure, which will not be repeated herein for the sake of brevity.

It should be understood that, the chip 900 mentioned in the embodiments of the present disclosure may also be referred to as a system on chip, a system chip, a chip system or a system-on-chip chip, etc.

It should be understood that, the processor in the embodiments of the present disclosure may be an integrated circuit chip and have a processing capability of signals. In the process of implementation, each step of the above embodiments of the method can be implemented by an integrated logic circuit of hardware in a processor or an instruction in software form. The above processor may be a general-purpose processor, a digital signal processor (DSP), an application specific integrated circuit, a field programmable gate array or other programmable logic devices, a discrete gate or a transistor logic device, a discrete hardware component. The disclosed methods, steps, and logical block diagrams in the embodiments of the present disclosure can be implemented or executed. The general-purpose processor may be a microprocessor or any conventional processor. The steps of the method disclosed in combination with the embodiments of the present disclosure may be directly embodied as being performed and completed by a hardware decoding processor, or by using a combination of hardware and software modules in the decoding processor. The software module may be located in the mature storage medium in the art such as a random memory, a flash memory, a read-only memory, a programmable read-only memory or an electrically erasable programmable memory, a register, etc. The storage medium is located in the memory, and the processor reads information in the memory and completes the steps in the above method in combination with its hardware.

It can be understood that the memory in the embodiments of the present disclosure may be a volatile memory or a non-volatile memory, or may include both volatile and non-volatile memories. Herein, the non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a random access memory (Random Access Memory, RAM), which is used as an external cache. By way of illustration, but not limitation, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memories of the systems and methods described herein is intended to include, but is not limited to, these and any other suitable types of memory.

It should be understood that the above-mentioned memory is an exemplary but not restrictive description. For example, the memory in the embodiments of this application can also be static random access memory (static RAM, SRAM), dynamic random access memory (dynamic RAM, DRAM), synchronous dynamic random access memory (synchronous DRAM, SDRAM), double data rate synchronous dynamic random access memory (double data rate SDRAM, DDR SDRAM), enhanced synchronous dynamic random access memory (enhanced SDRAM, ESDRAM), synch link dynamic random access memory (synch link DRAM, SLDRAM), direct rambus random access memory (Direct Rambus RAM, DR RAM) etc. That is, memories in embodiments of the present disclosure are intended to include, but are not limited to, these and any other suitable types of memories.

The embodiments of the present disclosure further provide a non-transitory computer-readable storage medium, configured to a computer program.

Optionally, the non-transitory computer readable storage medium may be applied to the UE in the embodiments of the present disclosure, and the computer program causes the UE to perform the procedure implemented by the UE in the various methods of the embodiments of the present disclosure, which will not be repeated herein for the sake of brevity.

In the embodiments of the present disclosure, a computer program product including computer program instructions is further provided.

Optionally, the computer program product may be applied to the UE in the embodiments of the present disclosure, and the computer program instructions cause the UE to perform the procedure implemented by the UE in the various methods of the embodiments of the present disclosure, which will not be repeated herein for the sake of brevity.

The embodiments of the present disclosure further provide a computer program.

Optionally, the computer program may be applied to the UE in the embodiments of the present disclosure, the computer program upon being executed on the UE, causes the UE to perform the corresponding procedure implemented by the UE in various methods of the embodiments of the present disclosure, which will not be repeated herein for the sake of brevity.

Those skilled in the art may realize that the units and algorithm steps of each example described in the disclosed embodiments can be implemented through electronic hardware, or a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the present disclosure.

Those skilled in the art may clearly understand that, for convenience and simplicity of description, the specific working processes of the system, the apparatus and the unit described above may refer to the corresponding processes in the above method embodiments, which may not be described repeatedly herein.

In several embodiments provided by the present disclosure, it should be understood that the disclosed system, apparatus and method may be implemented in other ways. For example, the embodiments of the device described above are only illustrative. For example, the division of units is only a logical function division, and there may be other division methods for actual implementation. For example, multiple units or components can be combined or integrated into another system, or some features may be ignored or may not be executed. On the other hand, the coupling or direct coupling or communicative connection between each other as shown or discussed above may be an indirect coupling or a communicative connection via some interfaces, apparatus or units, which may be electrical, mechanical, or in other forms.

The units described as separate components may be or may not be physically separated, and the components shown as units may be or may not be physical units, that is, they may be located in one place or distributed across multiple network units. A portion or all of the units may be selected according to actual needs to implement the purpose of the embodiments.

In addition, the functional units in the embodiments of the present disclosure may be integrated into a single processing unit or the functional units may exist physically and separately, or two or more units may be integrated into one unit.

If the described functions are implemented in a form of a software functional unit and sold or used as an independent product, they may be stored in a non-transitory computer readable storage medium. Based on this understanding, the technical solution of the present disclosure, or the portion that contributes to the existing technology or the portion of the technical solution, can be reflected in the form of a software product. The computer software product is stored in a storage medium, including several instructions to enable a computer device (which may be a personal computer, server, or network device, etc.) to perform all or a portion of the steps of the methods described in the various embodiments of the present disclosure. And the above described non-transitory storage medium includes: a USB flash disk, a mobile hard disk, a read-only memory (Read-Only Memory, ROM), a random access memory (Random Access Memory, RAM), a disk or a CD, and other medium that can store program code.

The above description is only a specific implementation of the embodiments of the present disclosure, but the protection scope of the embodiments of the present disclosure is not limited thereto, and any skilled in the art familiar with this technical field may easily think of changes or substitutions within the technical scope disclosed in the embodiments of the present disclosure, which should be all covered within the protection scope of the present disclosure. Therefore, the protection scope of the present disclosure shall be subject to the protection scope of the claims.

The term “and/or” herein is only an association relationship to describe associated objects, which indicates that there may be three kinds of relationships, for example, A and/or B may indicate three cases where: A exists alone, both A and B exist, and B exists alone. In addition, a character “/” herein generally indicates that related objects before and after “/” are in an “or” relationship.

What is claimed is:

1. An information transmission method, comprising:
sending, by a first user equipment (UE), resource selection auxiliary information to a second UE via a sidelink in response that a target condition is met;
wherein the target condition comprises at least one of:
the first UE detecting, in the sidelink, an event that triggers the resource selection auxiliary information to be sent; or
the first UE receiving request information sent by the second UE for requesting the resource selection auxiliary information.

2. The method according to claim 1, wherein the sending, by the first UE, the resource selection auxiliary information to the second UE via the sidelink comprises:
sending, by the first UE, a media access control (MAC) control element (CE) including the resource selection auxiliary information to the second UE via the sidelink.

3. The method according to claim 2, wherein in response that the target condition is the first UE receiving the request information sent by the second UE, the method further comprises:
discarding, by the first UE, the MAC CE or canceling, by the first UE, the MAC CE in response that the first UE fails to send the MAC CE within a first duration.

4. The method according to claim 2, wherein in response that the target condition is the first UE receiving the request information sent by the second UE, the method further comprises:
starting, by the first UE, a first timer, wherein a timer duration of the first timer is a first duration.

5. The method according to claim 4, wherein the method further comprises:
discarding, by the first UE, or canceling, by the first UE, the MAC CE in response that the first timer expires.

6. The method according to claim 4, wherein the method further comprises:
stopping, by the first UE, the first timer in response that the first UE sends or generates the MAC CE before the first timer expires.

7. The method according to claim 4, wherein a starting time of the first timer is determined according to the request information.

8. An information transmission method, comprising:
sending, by a second user equipment (UE), request information to a first UE;
wherein the request information is used to request the first UE to feed back resource selection auxiliary information.

9. The method according to claim 8, wherein the method further comprises:
selecting, by the second UE, a second resource from a sidelink resource pool based on the resource selection auxiliary information included in a received media access control (MAC) control element (CE) and a monitoring result of the sidelink if the second UE receives the MAC CE sent by the first UE in response to the request information within a second duration; wherein the second resource is used to carry data sent by the second UE to the first UE; or
selecting, by the second UE, a second resource from a sidelink resource pool based on a monitoring result of the sidelink if the second UE fails to receive a MAC CE sent by the first UE in response to the request information within a second duration.

10. The method according to claim 11, wherein the method further comprises:
starting, by the second UE, a second timer, wherein a timer duration of the second timer is a second duration.

11. The method according to claim 10, wherein the method further comprises:
selecting, by the second UE, a second resource from a sidelink resource pool based on the resource selection auxiliary information included in a received MAC CE and a monitoring result of the sidelink if the second UE receives the MAC CE sent by the first UE in response to the request information before the second timer expires; wherein the second resource is used to carry data sent by the second UE to the first UE; or
selecting, by the second UE, the second resource from the sidelink resource pool based on a monitoring result of the sidelink in response that the second timer expires.

12. The method according to claim 10, wherein the method further comprises:
stopping, by the second UE, the second timer if the second UE receives a MAC CE sent by the first UE in response to the request information before the second timer expires.

13. The method according to claim 10, wherein a starting time of the second timer is determined according to the request information.

14. A first user equipment (UE), comprising:
a memory, configured to store a computer program;
a processor, configured to call and run the computer program stored in the memory to enable the first UE to perform:
sending resource selection auxiliary information to a second UE via a sidelink in response that a target condition is met; wherein the target condition comprises at least one of:
the first UE detecting, in the sidelink, an event that triggers the resource selection auxiliary information to be sent; or
the first UE receiving request information sent by the second UE for requesting the resource selection auxiliary information.

15. The first UE according to claim 14, wherein the sending the resource selection auxiliary information to the second UE via the sidelink comprises:
sending a media access control (MAC) control element (CE) including the resource selection auxiliary information to the second UE via the sidelink.

16. The first UE according to claim 15, wherein in response that the target condition is the first UE receiving the request information sent by the second UE, the first UE further performs:
discarding the MAC CE or canceling the MAC CE in response that the first UE fails to send the MAC CE within a first duration.

17. The first UE according to claim 15, wherein in response that the target condition is the first UE receiving the request information sent by the second UE, the first UE further performs:
starting a first timer, wherein a timer duration of the first timer is a first duration.

18. The first UE according to claim 17, wherein the first UE further performs:
discarding or canceling the MAC CE in response that the first timer expires; or
stopping the first timer in response that the first UE sends or generates the MAC CE before the first timer expires.

19. The first UE according to claim 17, wherein a starting time of the first timer is determined according to the request information.

20. A second user equipment (UE), wherein the communication device comprises: a processor and a memory, wherein the memory is configured to store a computer program, the processor is configured to call and run the computer program stored in the memory to enable the communication device to perform the method according to claim 8.
